(19) United States
(12) Patent Application Publication
(10) Pub. No.: US 2026/0201273 A1
(43) Pub. Date: Jul. 16, 2026

(54) LIQUID LAUNDRY DETERGENT COMPOSITIONS CONTAINING CUCURBITURILS

(71) Applicant: Clariant International Ltd, Muttenz (CH)

(72) Inventors: Xiaoqiang GUO, Frankfurt am Main (DE); Carsten COHRS, Frankfurt am Main (DE); Natascha SCHELERO, Hamburg (DE); Carsten SCHAEFER, Frankfurt am Main (DE); Clemens LIEDEL, Frankfurt am Main (DE); Hiroe YAMADA, Frankfurt am Main (DE)

(73) Assignee: Clariant International Ltd, Muttenz (CH)

(21) Appl. No.: 19/132,394

(22) PCT Filed: Dec. 8, 2023
(86) PCT No.: PCT/EP2023/085002

§ 371 Date: May 23, 2025

(30) Foreign Application Priority Data
Dec. 12, 2022 (EP) 22212724.3

(51) Int. Cl. C11D 1/72; C11D 3/28; C11D 3/37

(52) U.S. Cl. CPC C11D 1/72; C11D 3/28; C11D 3/3719; C11D 3/3723; C11D 2111/12

(57) ABSTRACT

Liquid laundry detergent compositions comprising one or more cucurbiturils, one or more nonionic surfactants and water are described. These laundry detergent compositions may advantageously be used for treating fabrics through washing to remove malodor and/or to reduce malodor generated during wear after washing.

The present invention relates to liquid laundry detergent compositions comprising one or more cucurbiturils, one or more nonionic surfactants and water and to the use of the liquid laundry detergent compositions for treating fabrics through washing to remove malodor and/or to reduce malodor generated during wear after washing.

Laundry malodor is usually generated while garments are being worn. It usually contains various odorants, such as ammonia, sulfides, short and medium chain fatty acids, aldehydes and ketones. It results from soil attached to fabric being digested by microorganisms or from environmental odor adsorbed on fabric. Laundry malodor can build up on fabric over time and becomes rather persistent to removal by washing.

Laundry detergent compositions can usually remove malodor only partially from fabrics through the wash. Malodor is then still generated on fabric during wear after washing.

US 2020/0231907 A1 describes a laundry detergent composition, which includes a detergent surfactant and saccharomyces ferment filtrate. The laundry detergent composition provides a benefit in the elimination, inhibition, and/or reduction of any malodor, for example dank malodor, body malodor, or food malodor.

US 2011/146001 A1 describes a detergent laundry composition comprising a malodor control component having at least one volatile aldehyde and an acid catalyst, and methods of laundry detergents.

However, these technologies can only convert odorants of certain chemical groups, such as amine-based or sulfur-based malodor into non-smelly substances. They do not work on other types of odorants, such as aldehydes or fatty acids. Furthermore, those technologies only help to remove certain malodor through the wash, but can hardly reduce malodor generated during wear after washing.

There is still a need for malodor combating technologies, which can be used for treating fabrics through washing to remove malodor and/or to reduce malodor generated during wear after washing.

The object of the present invention is to provide liquid laundry detergent compositions which can be used for treating fabrics through washing to remove malodor and/or to reduce malodor generated during wear after washing.

It has been found that this object is achieved by liquid laundry detergent compositions comprising
Z1) one or more cucurbiturils selected from the group consisting of cucurbit[5]uril, cucurbit[6]uril, cucurbit[7]uril, cucurbit[8]uril and mixtures thereof,
and
Z2) one or more nonionic surfactants,
and
Z3) water.

A subject matter of the present invention therefore is liquid laundry detergent compositions comprising
Z1) one or more cucurbiturils selected from the group consisting of cucurbit[5]uril, cucurbit[6]uril, cucurbit[7]uril, cucurbit[8]uril and mixtures thereof,
and
Z2) one or more nonionic surfactants,
and
Z3) water.

Cucurbiturils are barrel-like molecules which can be prepared according to the process described in U.S. Pat. No. 10,626,119 B2.

The inventive liquid laundry detergent compositions have the advantage that they can be used for treating fabrics through washing to remove malodor and/or to reduce malodor generated during wear after washing.

A further advantage of the inventive liquid laundry detergent compositions is that they are effective on all chemical types of odorants, and not only on specific chemical types of odorants, such as amine-based or sulfur-based malodor.

The term “malodor generated during wear” in the context of the invention refers to the fact that during wear of fabrics malodor can be produced, e.g. because dirt or fatty soils attached to fabrics are continuously being degraded by microorganisms present on fabrics.

Preferably, component Z1) of the inventive liquid laundry detergent compositions comprises
a) cucurbit[5]uril in an amount from 0 to 20% by weight, more preferably in an amount from 0 to 10% by weight and even more preferably in an amount from 0 to 5% by weight; and
b) cucurbit[6]uril in an amount from 30 to 70% by weight, more preferably in an amount from 35 to 65% by weight and even more preferably in an amount from 40 to 60% by weight; and
c) cucurbit[7]uril in an amount from 20 to 50% by weight, more preferably in an amount from 25 to 45% by weight and even more preferably in an amount from 30 to 40% by weight; and
d) cucurbit[8]uril in an amount from 0 to 30% by weight, more preferably in an amount from 0 to 20% by weight and even more preferably in an amount from 5 to 15% by weight;
in each case based on the total weight of component Z1).

In a more preferred embodiment of the invention, component Z1) of the inventive liquid laundry detergent compositions comprises
a) cucurbit[5]uril in an amount from 0 or 0.1 to 20% by weight, even more preferably in an amount from 0 or 0.1 to 10% by weight and particularly preferably in an amount from 0 or 0.1 to 5% by weight; and
b) cucurbit[6]uril in an amount from 30 to 69.9% by weight, even more preferably in an amount from 35 to 64.9% by weight and particularly preferably in an amount from 40 to 59.9% by weight; and
c) cucurbit[7]uril in an amount from 20 to 50% by weight, even more preferably in an amount from 25 to 45% by weight and particularly preferably in an amount from 30 to 40% by weight; and
d) cucurbit[8]uril in an amount from 0 to 30% by weight, even more preferably in an amount from 0 to 20% by weight and particularly preferably in an amount from 5 to 15% by weight;
in each case based on the total weight of component Z1).

In a preferred embodiment of the invention, the lower limit of cucurbit[5]uril in component Z1) of the inventive liquid laundry detergent compositions is 0.1% by weight, based on the total weight of component Z1).

Preferably, the one or more nonionic surfactants of component Z2) of the inventive liquid laundry detergent compositions are selected from the formula (X)

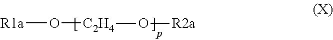

wherein
R1a is linear or branched C8-C18 alkyl or alkenyl, or linear or branched C8-C18 alkanoyl or alkenoyl,
R2a is hydrogen or methyl, and
p on a molar average, is a number from 3 to 100, preferably from 3 to 60, more preferably from 3 to 40, even more preferably from 4 to 20, and particularly preferably from 4 to 15.

In a more preferred embodiment of the invention, the one or more nonionic surfactants of component Z2) of the inventive liquid laundry detergent compositions are selected from the formula (X)

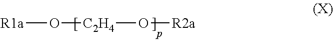

wherein
R1a is linear or branched C8-18 alkyl or alkenyl, preferably linear C8-C18 alkyl or alkenyl, more preferably linear C8-C14 alkyl and even more preferably linear C10-C14 alkyl,
R2a is hydrogen, and
p on a molar average, is a number from 4 to 20, preferably from 4 to 15 and more preferably from 4 to 10.

In another more preferred embodiment of the invention, the one or more nonionic surfactants of component Z2) of the inventive liquid laundry detergent compositions are selected from the formula (X)

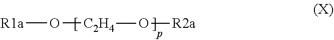

wherein
R1a is linear or branched C8-18 alkanoyl or alkenoyl, preferably linear C8-C18 alkanoyl or alkenoyl, more preferably linear C12-C18 alkanoyl or alkenoyl and even more preferably linear C16-C18 alkanoyl or alkenoyl,
R2a is methyl, and
p on a molar average, is a number from 4 to 20, preferably from 4 to 15 and more preferably from 4 to 12.

Preferably, the liquid laundry detergent compositions according to the invention comprise the one or more cucurbiturils of component Z1) in an amount from 0.01 to 5% by weight, more preferably in an amount from 0.01 to 2% by weight and even more preferably in an amount from 0.01 to 1% by weight, in each case based on the total weight of the liquid laundry detergent composition.

Preferably, the liquid laundry detergent compositions according to the invention comprise the one or more nonionic surfactants of component Z2) in an amount from 1 to 60% by weight, more preferably in an amount from 1 to 40% by weight, even more preferably in an amount from 1 to 30% by weight and particularly preferably in an amount from 2 to 20% by weight, in each case based on the total weight of the liquid laundry detergent composition.

Preferably, the liquid laundry detergent compositions according to the invention comprise
the one or more cucurbiturils of component Z1) in an amount from 0.01 to 5% by weight, more preferably in an amount from 0.01 to 2% by weight and even more preferably in an amount from 0.01 to 1% by weight; and
the one or more nonionic surfactants of component Z2) in an amount from 1 to 40% by weight, more preferably in an amount from 1 to 30% by weight and even more preferably in an amount from 2 to 20% by weight; and
water of component Z3) in an amount from 55 to 98.99% by weight, more preferably in an amount from 68 to 98.99% by weight and even more preferably in an amount from 79 to 97.99% by weight,
in each case based on the total weight of the liquid laundry detergent composition.

Preferably, the liquid laundry detergent compositions according to the invention comprise a further component Z4)
Z4) one or more polymers comprising one or more structural units derived from one or more monomers containing nitrogen.

Preferably, the one or more polymers of component Z4) of the liquid laundry detergent compositions according to the invention comprise one or more structural units derived from one or more monomers of the formulae (I), (II-a), (II-b), (II-c), (III), or mixtures thereof

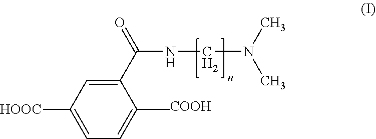

wherein
n is an integer from 1 to 20, preferably from 1 to 10, more preferably from 1 to 6, even more preferably is 2 or 3, and particularly preferably is 3,

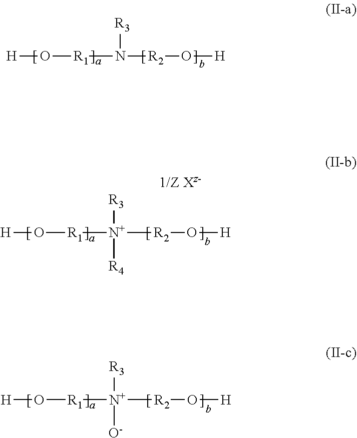

wherein
R₁ and R₂ are, independently of one another, selected from linear or branched alkylene groups represented by the formula (CₙH₂ₙ) wherein n is 2, 3 or 4,
R₃ is a group of the formula —(CⱼH₂ⱼO)ₖ—R₉₈, wherein j is 2, 3 or 4, preferably 2, k is, based on a molar average, a number from 0 to 10, preferably from 0 to 5, more preferably from 0 to 2 and even more preferably is 0, and Res is selected from the group consisting of alkyl, alkenyl, hydroxyalkyl, hydroxyalkenyl, phenyl alkyl, phenyl alkenyl, alkyl phenyl, and alkenyl phenyl, wherein the alkyl and alkenyl groups, either as such or as a part of the aforementioned hydroxyalkyl, hydroxyalkenyl, phenyl alkyl, phenyl alkenyl, alkyl phenyl or alkenyl phenyl groups, contain 6 or more than 6 carbon atoms, preferably from 6 to 30 carbon atoms and more preferably from 6 to 22 carbon atoms,
R₄ is a group of the formula —(Cⱼ₁H₂ⱼ₁O)ₖ₁—R₉₉, wherein j1 is 2, 3 or 4, preferably 2, k1 is, based on a molar average, a number from 0 to 10, preferably from 0 to 5, more preferably from 0 to 2 and even more preferably is 0, and R₉₉ is selected from the group consisting of hydrogen, alkyl, alkenyl, hydroxyalkyl, hydroxyalkenyl, phenyl alkyl, phenyl alkenyl, alkyl phenyl, and alkenyl phenyl, wherein the alkyl groups, either as such or as a part of the aforementioned hydroxyalkyl, phenyl alkyl or alkyl phenyl groups, contain from 1 to 30 carbon atoms, preferably from 1 to 22 carbon atoms and more preferably from 1 to 6 carbon atoms, and wherein the alkenyl groups, either as such or as a part of the aforementioned hydroxyalkenyl, phenyl alkenyl or alkenyl phenyl groups, contain from 2 to 30 carbon atoms, preferably from 2 to 22 carbon atoms and more preferably from 2 to 6 carbon atoms,
a and b are, based on a molar average, independently of one another, numbers from 1 to 200, preferably from 1 to 100, more preferably from 1 to 50, even more preferably from 1 to 25, and particularly preferably from 1 to 10, and
1/z X^{z-} is an anion, preferably selected from the group consisting of monovalent anions X⁻ (z=1), divalent anions ½ X²⁻ (z=2) and trivalent anions ⅓ X³⁻ (z=3) and more preferably selected from the group consisting of Cl⁻ (chloride), Br⁻ (bromide), CH₃—SO₄⁻ (methyl sulfate), C₂H₅—SO₄⁻ (ethyl sulfate), HCOO⁻ (formate), ⅓ C(OH)(COO⁻)(CH₂OOO⁻)₂ (citrate), CH₃—COO⁻ (acetate), NO₃⁻ (nitrate), ½ CO₃²⁻ (carbonate), ½ SO₄²⁻ (sulfate) and ⅓ PO₄³⁻ (phosphate),

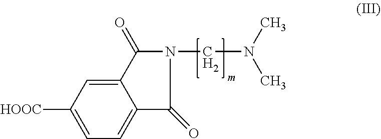

wherein
m is an integer from 1 to 20, preferably from 1 to 10, more preferably from 1 to 6, even more preferably is 2 or 3, and particularly preferably is 3.

More preferably, the one or more polymers of component Z4) of the liquid laundry detergent compositions according to the invention that comprise one or more structural units derived from one or more monomers of the formulae (I), (II-a), (II-b), (II-c), (111), or mixtures thereof, further comprise
A) one or more structural units derived from terephthalic acid or dimethyl terephthalate, and
B) one or more structural units derived from ethylene glycol or propylene glycol.

Even more preferably, the one or more polymers of component Z4) of the liquid laundry detergent compositions according to the invention that comprise one or more structural units derived from one or more monomers of the formulae (I), (II-a), (II-b), (II-c), (111), or mixtures thereof, and further comprise one or more structural units A) and one or more structural units B), further comprise one or more structural units derived from one or more polyalkyleneglycol monoalkylethers of the formula (V)

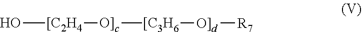

wherein,
R₇ is linear or branched (C₁-C₃₀)-alkyl, preferably linear or branched (C₁-C₄)-alkyl, and more preferably methyl,
c and d are, based on a molar average, independently of one another, numbers from 0 to 200, and the sum of c+d is from 2 to 400, preferably from 2 to 350, and more preferably from 2 to 150, the [C₂H₄—O] and [C₃H₆—O]groups of the formula (V) may be arranged blockwise, alternating, periodically and/or statistically, preferably blockwise and/or statistically, and either of the [C₂H₄—O] and [C₃H₆—O]groups of the formula (V) can be linked to —R₇ and/or —OH.

Particularly preferably, the one or more polymers of component Z4) of the liquid laundry detergent compositions according to the invention are selected from the group consisting of
polymers comprising one or more structural units derived from one or more monomers of the formulae (I) or (III) or mixtures thereof, and one or more structural units derived from one or more monomers of the formula (V), and one or more structural units of the component A) and one or more structural units of the component B);
polymers comprising one or more structural units derived from one or more monomers of the formula (II-a), and one or more structural units derived from one or more monomers of the formula (V), and one or more structural units of the component A) and one or more structural units of the component B);
polymers comprising one or more structural units derived from one or more monomers of the formula (II-b), and one or more structural units derived from one or more monomers of the formula (V), and one or more structural units of the component A) and one or more structural units of the component B); and
polymers comprising one or more structural units derived from one or more monomers of the formula (II-c), and one or more structural units derived from one or more monomers of the formula (V), and one or more structural units of the component A) and one or more structural units of the component B).

Preferably, the liquid laundry detergent compositions according to the invention comprise the one or more polymers of component Z4) in an amount from 0.01 to 10% by weight, more preferably in an amount from 0.01 to 5% by weight, even more preferably in an amount from 0.05 to 5% by weight and particularly preferably in an amount from 0.05 to 3% by weight, in each case based on the total weight of the liquid laundry detergent composition.

Preferably, the liquid laundry detergent compositions according to the invention comprise a further component Z5)
Z5) one or more anionic surfactants selected from the group consisting of soaps, anionic surfactants containing sulfate groups, anionic surfactants containing sulfonate groups and mixtures thereof.

More preferably, the one or more anionic surfactants of component Z5) of the liquid laundry detergent compositions according to the invention are selected from
a) soaps, preferably alkali metal salts of saturated or unsaturated fatty acids with 12 to 18 carbon atoms, preferably with 16 to 18 carbon atoms; whereby such fatty acids may also be used in partially neutralized forms, or
b) anionic surfactants containing sulfate groups of the formula (XI)

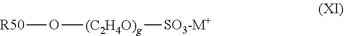

wherein
R50 is a C8-C20 alkyl group, preferably a C12-C14 alkyl group,
g on a molar average, is a number from 1 to 20, preferably from 1 to 10, more preferably from 1 to 5, and
M⁺ is a cation, preferably Na⁺, K⁺, ammonium, alkylammonium, or alkanolammonium, more preferably Na⁺, or
c) anionic surfactants containing sulfonate groups selected from the group consisting of linear alkylbenzene sulfonic acids, salts of linear alkylbenzene sulfonic acids, alkyl ethoxylated sulfonates, alkyl propoxy sulfonates, alkyl sulfonates, and mixtures thereof,
or mixtures thereof.

Preferably, the liquid laundry detergent compositions according to the invention comprise the one or more anionic surfactants of component Z5) in an amount from 1 to 30% by weight, more preferably in an amount from 5 to 25% by weight, and even more preferably in an amount from 5 to 20% by weight, in each case based on the total weight of the liquid laundry detergent composition.

Preferably, the liquid laundry detergent compositions according to the invention comprise further components typically used in liquid laundry detergent compositions and known to the person skilled in the art, such as fragrances, enzymes, foam inhibitors, optical brighteners, chelators and preservatives.

The liquid laundry detergent compositions according to the invention may advantageously be used for treating fabrics through washing to remove malodor and/or to reduce malodor generated during wear after washing.

A further subject matter of the present invention is the use of liquid laundry detergent compositions according to the invention for treating fabrics through washing to remove malodor.

A further subject matter of the present invention is the use of liquid laundry detergent compositions according to the invention for treating fabrics through washing to reduce malodor generated during wear after washing.

The examples below are intended to illustrate the invention in detail without, however, limiting it thereto.

### EXAMPLE 1—PREPARATION OF POLYMER I

### Preparation of the Precursor:

100 g (0.51 mol) of trimellitic anhydride is solubilized in acetone by stirring in a reaction vessel under a nitrogen stream. 53 g (0.51 mol) of 3-(dimethylamino)-1-propyl-amine is slowly added into the reaction vessel at 20° C. and mixing is continued for 1 hour. The reaction temperature is increased to 50° C. for 30 minutes and then increased to reflux temperature for 4 hours. Acetone and water are then distilled off and the precursor precipitates from the system. The precipitated precursor is collected and washed with acetone and dried overnight.

### Preparation of the Polymer I:

26.35 g (0.14 mol) of dimethyl terephthalate (DMT), 20.00 g (0.26 mol) of 1,2-propylene glycol (PG), 2.10 g (0.007 mol) of the precursor, 71.43 g (0.036 mol) of mPEG2000 (mono hydroxyl-functional polyethylene glycol monomethyl ether, average molecular weight 2000 g/mol) and 0.1 g of sodium acetate (NaOAc) (anhydrous) are weighed into a reaction vessel at room temperature. For the melting process and homogenization, the mixture is heated up to 70° C. 0.04 g of tetraisopropyl orthotitanate (IPT) is added and the mixture is further heated up to 170° C. for 1 hour and then up to 210° C. for a further 1 hour sparged by a nitrogen stream. During the transesterification, methanol is released from the reaction and is distilled out of the system (distillation temperature<55° C.). After 2 hours at 210° C. nitrogen is switched off and the pressure is reduced to 400 mbar over 3 hours. Subsequently, the mixture is heated up to 230° C. At 230° C., the pressure is reduced to 1 mbar over 160 minutes. Once the polycondensation reaction has started, 1,2-propylene glycol is distilled out of the system. The mixture is stirred for 4 hours at 230° C. and a pressure of 1 mbar. The reaction mixture is cooled down to 140-150° C. Vacuum is released with nitrogen and the molten polymer is transferred out of the reactor and cooled down.

### EXAMPLE 2—PREPARATION OF LIQUID LAUNDRY DETERGENT COMPOSITIONS

Liquid laundry detergent compositions A and B have been prepared. The ingredients of these compositions and the amounts of the ingredients are shown in Table 1.

TABLE 1
Liquid laundry detergent compositions A and B

| | A | B |
|---|---|---|
| | (Comparative) | (Inventive) |
| | amount of | amount of |
| | ingredient | ingredient |
| Ingredient | [weight %] | [weight %] |
| linear alkylbenzene sulfonic | 5.2 | 5.2 |
| acid | | |
| sodium laureth sulfate | 6.5 | 6.5 |
| ethoxylated lauryl alcohol | 5.2 | 5.2 |
| with 7 EO | | |
| cucurbituril sample | 0 | 0.5 |
| comprising | | |
| cucurbit[6]uril (50% by | | |
| weight), cucurbit[7]uril (35% | | |
| by weight) and | | |
| cucurbit[8]uril (10% by | | |
| weight) | | |
| polymer I | 0 | 2.5 |
| glycerol | 2.4 | 2.4 |
| ethanol | 1.2 | 1.2 |
| sodium citrate | 1.7 | 1.7 |
| NaOH | 1.2 | 1.2 |
| water | fill up to 100 | fill up to 100 |
| pH | 8.5 | 8.5 |

### EXAMPLE 3—FABRIC WASHING AND MALODOR REDUCING

### Prewashing of Fabrics:

The washing conditions for the prewashing of the test fabrics are shown in Table 2.

TABLE 2
Washing conditions (prewashing)

| Washing machine | Linitester | |
|---|---|---|
| Hardness of water | 15° H | |
| Washing temperature | 40° C. | |
| Washing time | 30 | min |
| Detergent concentration | 4 | g/L |

As test fabrics, white polyester standard fabrics (30A) were used. The prewashed fabrics (the fabrics were prewashed with the liquid laundry detergent composition A or B) were then soiled with an artificial malodor composition.

### Artificial Malodor Composition:

The artificial malodor composition was prepared by mixing 10 mg of 2,3-butanedione, 5 mg of octanal, 30 mg of isovaleraldehyde, 300 mg of isovaleric acid and 50 mg of hexanal in 1 L of water.

### Analytic Procedure:

The soiled fabrics were then packed into Headspace GC vials and the vials were then closed tightly and analyzed.

Analytical evaluation of malodor in the vials was conducted through a headspace measurement. A Gas Chromatograph Agilent 9000 Intuvo equipped with an autosampler Agilent 7697A equipped with a headspace extracting syringe, a Mass Detector Agilent MSD 5977B was used.

The headspace vials were equilibrated at 60° C. for 30 minutes at the autosampler before the measurement. A gas phase sample of 1000 μL was extracted from the vial and injected into the GC column.
Carrier gas: Helium 22.7 psi, split 5:1
Column: DB-624 UI (length 60 m, diameter 250 μm, size of film 1.4 μm)
Oven: Initial 40° C.—Hold time 2 min—Rate 20° C./min—Temperature 260° C.—Hold time 5 min

Mass detector parameter: run in select ion mode. The peak area of each odorant was then integrated and recorded.

The relative peak areas for the odorants measured in the sample headspace are shown in Table 3.

TABLE 3
Relative peak areas* for odorants measured in sample headspace

| Samples | 2,3-butadione | isovaleraldehyde | hexanal | octanal |
|---|---|---|---|---|
| Fabrics washed with | 100 | 100 | 100 | 100 |
| comparative | | | | |
| composition A | | | | |
| Fabrics washed with | 77 | 75 | 70 | 40 |
| inventive composition | | | | |
| B | | | | |

*The peak areas of the individual odorants in the example containing fabrics prewashed with liquid laundry detergent composition A were normalized as 100. From Table 3 it can be clearly seen that the malodor intensity from the fabrics prewashed with the liquid laundry detergent composition B (inventive) is lower than from the fabrics prewashed with the liquid laundry detergent composition A (comparative).

1-12. (canceled)

13. A liquid laundry detergent composition comprising
Z1) one or more cucurbiturils selected from the group consisting of cucurbit[5]uril, cucurbit[6]uril, cucurbit[7]uril, cucurbit[8]uril and mixtures thereof;
Z2) one or more nonionic surfactants;
and
Z3) water.

14. The liquid laundry detergent composition according to claim 13, wherein component Z1) comprises
a) cucurbit[5]uril in an amount of from 0 to 20% by weight,
b) cucurbit[6]uril in an amount of from 30 to 70% by weight,
c) cucurbit[7]uril in an amount of from 20 to 50% by weight, and
d) cucurbit[8]uril in an amount of from 0 to 30% by weight,
in each case based on the total weight of component Z1).

15. The liquid laundry detergent composition according to claim 13, wherein component Z1) comprises
a) cucurbit[5]uril in an amount of from 0.1 to 5% by weight,
b) cucurbit[6]uril in an amount of from 40 to 59.9% by weight,
c) cucurbit[7]uril in an amount of from 30 to 40% by weight, and
d) cucurbit[8]uril in an amount of from 5 to 15% by weight,
in each case based on the total weight of component Z1).

16. The liquid laundry detergent composition according to claim 13, wherein the one or more nonionic surfactants of component Z2) are of the formula (X) 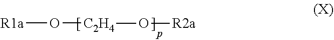
wherein
R1a is linear or branched C₈-C₁₈ alkyl or alkenyl, or linear or branched C₈-C₁₈ alkanoyl or alkenoyl,
R2a is hydrogen or methyl, and
p on a molar average, is a number from 3 to 100.

17. The liquid laundry detergent composition according to claim 13, wherein the one or more nonionic surfactants of component Z2) are of the formula (X) 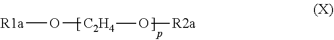
wherein
R1a is a linear or branched C₈-C₁₈ alkyl or alkenyl,
R2a is hydrogen, and
p on a molar average, is a number from 4 to 20.

18. The liquid laundry detergent composition according to claim 13, wherein the one or more nonionic surfactants of component Z2) are selected from the formula (X) 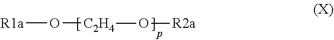
wherein
R1a is a linear or branched C₈-C₁₈ alkanoyl or alkenoyl,
R2a is methyl, and
p on a molar average, is a number from 4 to 20.

19. The liquid laundry detergent composition according to claim 13, wherein the composition comprises the one or more cucurbiturils of component Z1) in an amount of from 0.01 to 5% by weight, based on the total weight of the liquid laundry detergent composition.

20. The liquid laundry detergent composition according to claim 13, wherein the composition comprises the one or more nonionic surfactants of component Z2) in an amount of from 1 to 60% by weight, based on the total weight of the liquid laundry detergent composition.

21. The liquid laundry detergent composition according to claim 13, wherein the composition comprises a further component Z4) one or more polymers comprising one or more structural units derived from one or more monomers containing nitrogen.

22. The liquid laundry detergent composition according to claim 21, wherein the one or more polymers of component Z4) comprise one or more structural units derived from one or more monomers of the formulae (I), (II-a), (II-b), or (II-c), or (III), wherein
formula (I) is 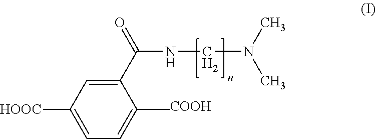
wherein n is an integer from 1 to 20,
formulae (II-a), (II-b), and (II-c) are 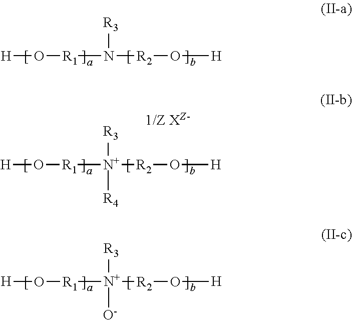
wherein
R₁ and R₂ are each, independently, a linear or branched alkylene group represented by the formula (CₙH₂ₙ), wherein n is 2, 3 or 4,
R₃ is a group of the formula —(CⱼH₂ⱼO)ₖ—R₉₈, wherein
j is 2, 3, or 4;
k is, based on a molar average, a number from 0 to 10; and
R₉₈ is selected from the group consisting of: C₆ or higher alkyl; C₆ or higher alkenyl; C₆ or higher hydroxyalkyl; C₆ or higher hydroxyalkenyl; phenyl-(C₆ or higher)-alkyl; phenyl-(C₆ or higher)-alkenyl; (C₆ or higher)-alkyl-phenyl; and (C₆ or higher)-alkenyl-phenyl;
R₄ is a group of the formula —(Cj1H₂ⱼ₁O)ₖ₁—R₉₉, wherein
j1 is 2, 3, or 4;
k1 is, based on a molar average, a number from 0 to 10; and
R₉₉ is selected from the group consisting of: hydrogen; C₁-C₃₀ alkyl; C₂-C₃₀ alkenyl; C₁-C₃₀ hydroxyalkyl; C₂-C₃₀ hydroxyalkenyl; phenyl-(C₁-C₃₀)-alkyl; phenyl-(C₂-C₃₀)-alkenyl; (C₁-C₃₀)-alkyl-phenyl; and (C₂-C₃₀)-alkenyl-phenyl;
a and b are each, independently, based on a molar average, a number from 1 to 200; and
1/z X^{z-} is an anion selected from the group consisting of monovalent anions X⁻ (z=1), divalent anions ½ X²⁻ (z=2), and trivalent anions ⅓ X³⁻ (z=3),
and formula (III) is 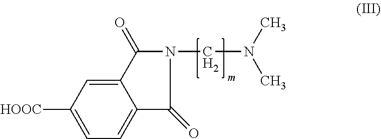
wherein m is an integer from 1 to 20.

23. The liquid laundry detergent composition according to claim 21, wherein the composition comprises the one or more polymers of component Z4) in an amount of from 0.01 to 10% by weight, based on the total weight of the liquid laundry detergent composition.

24. A method of removing malodor from a fabric, the method comprising contacting the fabric with the liquid laundry detergent composition according to claim 13.

25. A liquid laundry detergent composition comprising
Z1) cucurbit[5]uril in an amount of from 0 to 20% by weight, cucurbit[6]uril in an amount of from 40 to 60% by weight, cucurbit[7]uril in an amount of from 25 to 45% by weight, and cucurbit[8]uril in an amount of from 5 to 15% by weight, in each case based on the total weight of component Z1);
Z2) one or more nonionic surfactants of the formula (X) 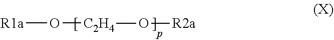
wherein
R1a is a linear or branched C₈-C₁₈ alkyl or alkenyl or a linear or branched C₈-C₁₈ alkanoyl or alkenoyl,
R2a is hydrogen or methyl, and
p on a molar average, is a number from 4 to 20;
and
Z3) water.

26. The liquid laundry detergent composition according to claim 25, wherein the composition comprises, based on the total weight of the liquid laundry detergent composition, the one or more cucurbiturils of component Z1) in an amount of from 0.01 to 5% by weight and the one or more nonionic surfactants of component Z2) in an amount of from 1 to 60% by weight.

27. The liquid laundry detergent composition according to claim 25, wherein the composition comprises a further component Z4) one or more polymers comprising one or more structural units derived from one or more monomers containing nitrogen.

28. The liquid laundry detergent composition according to claim 27, wherein the one or more polymers of component Z4) comprise one or more structural units derived from one or more monomers of the formulae (I), (II-a), (II-b), or (II-c), or (III), wherein
formula (I) is 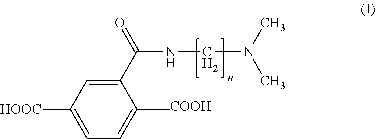
wherein n is an integer from 1 to 20,
formulae (II-a), (II-b), and (II-c) are 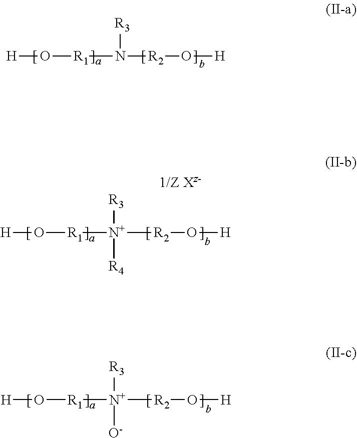
wherein
R₁ and R₂ are each, independently, a linear or branched alkylene group represented by the formula (CₙH₂ₙ), wherein n is 2, 3 or 4,
R₃ is a group of the formula —(CⱼH₂ⱼO)ₖ—R₉₈, wherein
j is 2, 3, or 4;
k is, based on a molar average, a number from 0 to 10; and
R₉₈ is selected from the group consisting of: C₆ or higher alkyl; C₆ or higher alkenyl; C₆ or higher hydroxyalkyl; C₆ or higher hydroxyalkenyl; phenyl-(C₆ or higher)-alkyl; phenyl-(C₆ or higher)-alkenyl; (C₆ or higher)-alkyl-phenyl; and (C₆ or higher)-alkenyl-phenyl;
R₄ is a group of the formula —(Cj1H₂ⱼ₁O)ₖ₁—R₉, wherein
j1 is 2, 3, or 4;
k1 is, based on a molar average, a number from 0 to 10; and
R₉₉ is selected from the group consisting of: hydrogen; C₁-C₃₀ alkyl; C₂-C₃₀ alkenyl; C₁-C₃₀ hydroxyalkyl; C₂-C₃₀ hydroxyalkenyl; phenyl-(C₁-C₃₀)-alkyl; phenyl-(C₂-C₃₀)-alkenyl; (C₁-C₃₀)-alkyl-phenyl; and (C₂-C₃₀)-alkenyl-phenyl;
a and b are each, independently, based on a molar average, a number from 1 to 200; and
1/z X^{z-} is an anion selected from the group consisting of monovalent anions X⁻ (z=1), divalent anions ½ X²⁻ (z=2), and trivalent anions ⅓ X³⁻ (z=3),
and formula (III) is 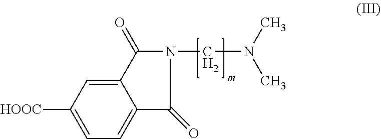
wherein m is an integer from 1 to 20.
